(19) United States
(12) Patent Application Publication
(10) Pub. No.: US 2012/0127516 A1
(43) Pub. Date: May 24, 2012

(54) PORTABLE DEVICE AND PRINTING METHOD THEREOF

(75) Inventors: Johnny Chen, Santa Ana, CA (US); Wei-Cheng Wang, Santa Ana, CA (US)

(73) Assignee: I O INTERCONNECT, LTD., Santa Ana, CA (US)

(21) Appl. No.: 13/050,947

(22) Filed: Mar. 18, 2011

Related U.S. Application Data
(60) Provisional application No. 61/416,281, filed on Nov. 22, 2010.

(51) Int. Cl. G06F 3/12

(52) U.S. Cl. 358/1.15

(57) ABSTRACT

Another embodiment of the invention provides a print system including a portable device having first data; a third party; and a print server. The printer server connects to at least one printer, wherein when the portable device wants to print the first data, the portable device transmits the first data and a print command to the third party, and the printer server monitors the third party to determine whether there is data designated to the print server, and if yes, the printer server acquires and transmits the first data to the printer for printing.

### CROSS REFERENCE TO RELATED APPLICATIONS

This application claims the benefit of U.S. Provisional Application No. 61/416,281, filed Nov. 22, 2010, the entirety of which is incorporated by reference herein.

### BACKGROUND OF THE INVENTION

1. Field of the Invention

The present invention relates to a printing method, and more particularly to a printing method for a portable device.

2. Description of the Related Art

With the growth of the usage of the portable device, a problem has been raised: inefficient connection of the portable device to print a document. One solution is to connect the portable device to a computer and print the document of the portable device from a printer through the control of the computer. However, this solution wastes time and is not convenient for a user. Another solution is directly connect the portable device to a printer and print the document from a printer. Thus, the portable device has to find out which printer is available, download and install a corresponding driver therein, connect to the printer, and print the document from the printer. The procedure is complicated and if the format of the document to be printed is not supported by the portable device, the printer may not correctly print the document.

### BRIEF SUMMARY OF THE INVENTION

An embodiment of the invention provides a portable device to print data from a printer via a third party. The portable device comprises a storage device storing first data to be printed and a processor to execute a client-side program to print the first data. The client-side program comprises the steps of: transmitting the first data to the third party; transmitting a printing command to the third party; monitoring the third party by a server to check whether there is data designated to the server for printing; acquiring the first data and transmitting the first data, by the server, to a printer; transmitting a printing result designated to the portable device, by the server, to the third party; and acquiring the printing result by the portable device.

Another embodiment of the invention provides a printing method for a portable device. The method comprises transmitting first data from the portable device to a third party; transmitting a printing command generated by the portable device to the third party; monitoring the third party, by a server, to check whether there is data designated to the server for printing; acquiring the first data and transmitting the first data, by the server, to a printer; printing the first data by the printer; transmitting a printing result designated to the portable device, by the server, to the third party; and acquiring the printing result by the portable device.

Another embodiment of the invention provides a print system comprising a portable device having first data to be printed; a third party; and a print server. The printer server connects to at least one printer, wherein when the portable device wants to print the first data, the portable device transmits the first data and a print command to the third party, and the printer server monitors the third party to determine whether there is data designated to the print server, and if yes, the printer server acquires and transmits the first data to the printer for printing.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of a portable device printing mechanism with a third party according to one embodiment of the invention.

FIG. 2 is a schematic diagram of a portable device printing mechanism with a third party according to another embodiment of the invention.

FIG. 3 is a printing procedure for a portable device according to one embodiment of the invention.

FIG. 4 is a schematic diagram of a portable device printing mechanism with a third party according to another embodiment of the invention.

FIG. 5 is a schematic diagram of a portable device printing mechanism with a third party according to another embodiment of the invention.

FIG. 6 is a schematic diagram of a portable device printing mechanism with a third party according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

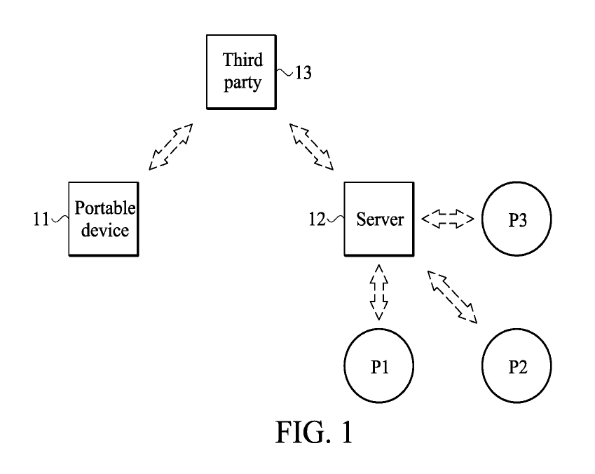

FIG. 1 is a schematic diagram of a portable device printing mechanism with a third party according to one embodiment of the invention. The server 12 connects to at least one printer and controls the printers to print data. The server 12 communicates with the printers, such as printers P1, P2 and P3, via a cable, a USB cable, or a wireless interface. The wireless interface may be a WiFi interface, a Bluetooth interface, an IrDA interface, a CDMA interface or other similar interface. In the present innovation, the portable device 11 does not directly communicate with the server 12. All the data, commands, requests or other similar data exchanged between the portable device 11 and the server 12 must be transferred by the third party 13.

When the portable device 11 wants to print a first data, the portable device 11 first transmits the first data to the third party 13, and then transmits a print command to the third party 13. In one embodiment, the first data is transformed into the first data with the XML format. The server 12 monitors the third party 13 to see whether there is data designated to the server 12 or the printers P1, P2 or P3. The user using the portable device 11 can know which printers are available by the software embedded in the portable device 11. The first data contains a label indicating the destination printer. The label may comprise a first unique identification of the printer. The label may also comprise a second unique identification of the server 12. The server 12 monitors the third party 13 continuously or periodically to determine whether there is data designated to the server 12. If yes, the server 12 acquires the first data and transmits it to the target printer. After the target printer finishes printing, the target printer transmits the printing result to the server 12 and the server 12 uploads the printing result designated to the portable device 11 to the third party 13. It is noted that the printing result may also contain a label indicating the portable device 11 and the label may comprise a third unique identification of the portable device 11.

The portable device 11 monitors the third party 13 continuously or periodically to determine whether there is a printing result designated to the portable device 11. If yes, the portable device 11 acquires the printing result. In the present innovation, the third party 13 exchanges information or data between the portable device 11 and the server 12 only, and the third party 13 does not voluntarily transmit data to the server 12 or the portable device 11. In other words, when the portable device 11 accesses the third party 13, the control of the third party 13 is transferred to the portable device 11, and when the server 12 accesses the third party 13, the control of the third party 13 is transferred to the server 12. In another embodiment, the third party can be accessed by both the portable device 11 and the server 12. In one example, the third party 13 is merely a storage medium and is capable of being accessed by both the server 12 and the portable device 11. The third party 13 may contain a security mechanism to verify the server 12 and the portable device 11, and after the verification procedure has passed verification, the server 12 and the portable device 11 are authorized to access the third party 13.

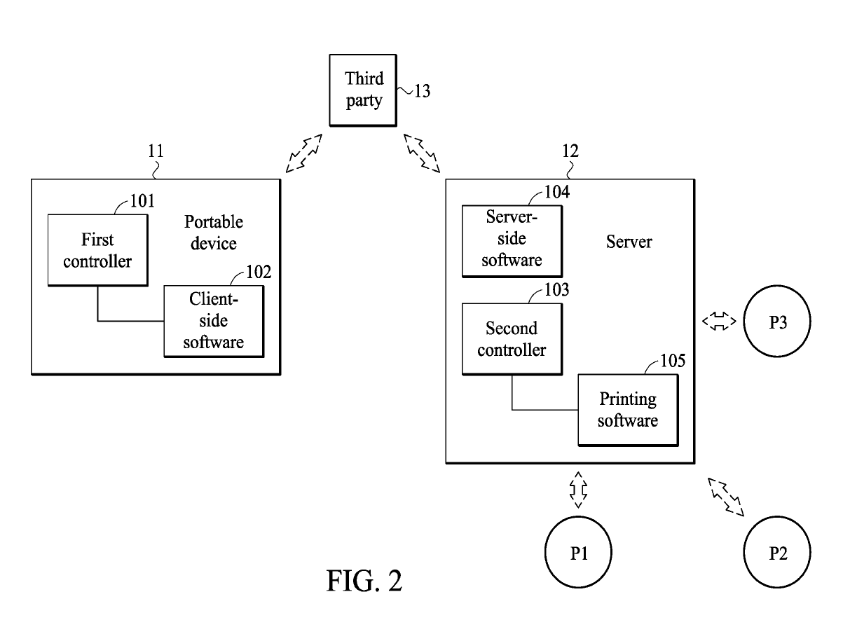

FIG. 2 is a schematic diagram of a portable device printing mechanism with a third party according to another embodiment of the invention. The portable device 11 comprises a first controller 101 and a client-side software 102. The server 12 comprises a second controller 103, a server-side software 104 and a printing software 105. The client-side software 102 and the server-side software 104 first execute a security verification procedure with the third part 13 to get the access right of the third party 13. In the present innovation, the third party 13 plays a role for exchanging information or data between the portable device 11 and the server 12 only, and the third party 13 does not voluntarily transmit data to the server 12 or the portable device 11. In other words, when data is being transmitted between the third party 13 and the portable device 11 or the server 12, the third party 13 can be regarded as a peripheral device of the portable device 11 or the server 12. Furthermore, the portable device 11 does not directly communicate with the server 12. All data, commands, requests or other similar messages exchanged between the portable device 11 and the server 12 must be transferred by the third party 13. In another embodiment, the format of the data, commands, requests or other similar messages exchanged between the portable device 11 and the server 12 will be transformed into an XML format.

When the portable device 11 wants to print a first data, the first controller 101 executes the client-side software 102 to transmit the first data to the third party 13, and then transmits a command to the third party 13. The server-side software 104 executed by the second controller 103 monitors the third party 13 to see whether there is data designated to the server 12 or the printers P1, P2 or P3. The user using the portable device 11 can know which printers are available by the client-side software 102 embedded in the portable device 11. The first data contains a label indicating the destination printer. The label may comprise a first unique identification of the printer P1, P2 or P3. The label may also comprise a second unique identification of the server 12. The server-side software 104 monitors the third party 13 continuously or periodically to determine whether there is data designated to the server 12. If yes, the second controller 103 acquires the first data and transmits it to the target printer via the printing software 105. After the target printer finishes printing, the target printer transmits the printing result to the server 12 and the second controller 103 uploads the printing result designated to the portable device 11 to the third party 13 by the server-side software 104. It is noted that the printing result may also contain a label indicating that portable device 11 and the label may comprise a third unique identification of the portable device 11.

The client-side software 102 monitors the third party 13 continuously or periodically to determine whether there is a printing result designated to the portable device 11. If yes, the first controller 101 acquires the printing result by the client-side software 102. In the present innovation, the third party 13 exchanges information or data between the portable device 11 and the server 12 only, and the third party 13 does not voluntarily transmit data to the server 12 or the portable device 11. In one example, the third party 13 is merely a storage medium and is capable of being accessed by both the server 12 and the portable device 11.

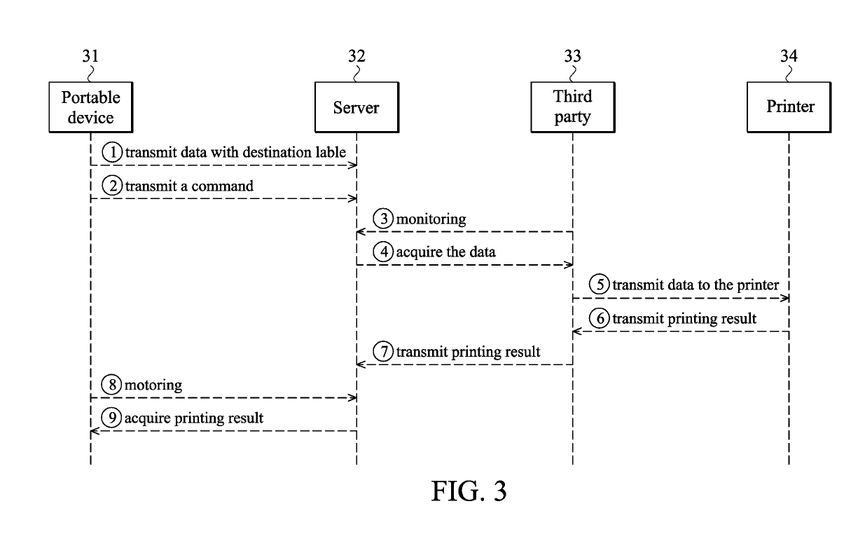

FIG. 3 is a printing procedure for a portable device according to one embodiment of the invention. The following steps explain the operation of the printing procedure.

Step 1: The portable device 31 first transmits the first data to be printed to the third party 32.

Step 2: The portable device 31 transmits a print command to the third party 32.

Step 3: The server 33 monitors the third party 32 to see whether there is data designated to the server 33 or the printer 34.

Step 4: If there is data designated to the server 33 or the printer 34, the server 33 acquires the first data from the third party 32.

Step 5: The server 33 transmits the first data to the printer 34 for printing.

Step 6: The printer 34 transmits the printing result to the server 33 after printing the first data.

Step 7: The server 33 uploads the printing result designated to the portable device 31 to the third party 32, wherein the server 33 may modify the printing result from the printer 34 and adds the label corresponding to the portable device 31 to the printing result.

Step 8: The portable device 31 monitors the third party 32 continuously or periodically to determine whether there is a printing result designated to the portable device 31.

Step 9: If there is a printing result designated to the portable device 31, the portable device 31 acquires the printing result.

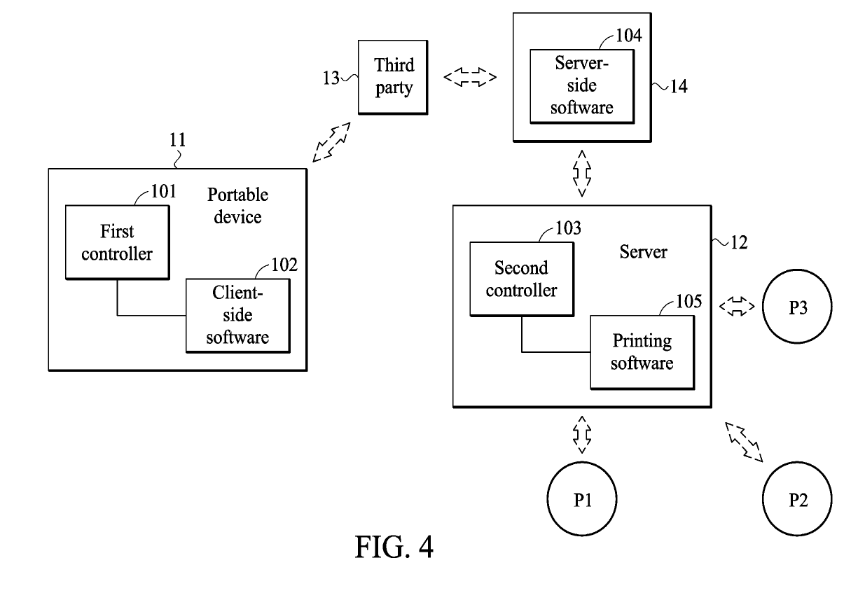

FIG. 4 is a schematic diagram of a portable device printing mechanism with a third party according to another embodiment of the invention. The most different feature of this embodiment is that the server-side software 104 is embedded in a dongle 14. The dongle 14 connects to the server 12, a hard disk of the server 12 or a router of an internet network, and stores the server-side software 104 and corresponding authorization information.

The portable device 11 comprises a first controller 101 and a client-side software 102. The server 12 comprises a second controller 103 and a printing software 105. The client-side software 102 and the server-side software 104 first execute a security verification procedure with the third party 13 to get the access right of the third party 13. In the present innovation, the third party 13 is used for exchanging the information or data between the portable device 11 and the server 12 only, and the third party 13 does not voluntarily transmit data to the server 12 or the portable device 11. Furthermore, the portable device 11 does not directly communicate with the server 12. All the data, commands, requests or other similar information exchanged between the portable device 11 and the server 12 must be transferred by the third party 13.

When the portable device 11 wants to print a first data, the first controller 101 executes the client-side software 102 to transmit the first data to the third party 13, and then transmits a print command to the third party 13. The server-side software 104 executed by the second controller 103 monitors the third party 13 to see whether there is data designated to the server 12 or the printers P1, P2 or P3. The user using the portable device 11 can know which printers are available by the client-side software 102 embedded in the portable device 11 and user can designate the specific printer for printing. The first data contains a label indicating the destination printer. The label may comprise a first unique identification of the printer P1, P2 or P3. The label may also comprise a second unique identification of the server 12. The server-side software 104 monitors the third party 13 continuously or periodically to determine whether there is data designated to the server 12. If yes, the server-side software 104 acquires and passes the first data to the server 12. When receiving the first data, the second controller 103 transmits the first data to the target printer and executes the printing software 105. In another embodiment, the printing software 105 deals with the first data to determine which printer is the target printer.

After the target printer finishes printing, the target printer transmits the printing result to the server 12 and the second controller 103 uploads the printing result designated to the portable device 11 to the third party 13 by the server-side software 104. It is noted that the printing result may also contain a label indicating the portable device 11 and the label may comprise a third unique identification of the portable device 11. The client-side software 102 monitors the third party 13 continuously or periodically to determine whether there is a printing result designated to the portable device 11. If yes, the first controller 101 acquires the printing result by the client-side software 102. In the present innovation, the third party 13 exchanges information or data between the portable device 11 and the server 12 only, and the third party 13 does not voluntarily transmit data to the server 12 or the portable device 11. In one example, the third party 13 is merely a storage medium and is capable of being accessed by both the server 12 and the portable device 11.

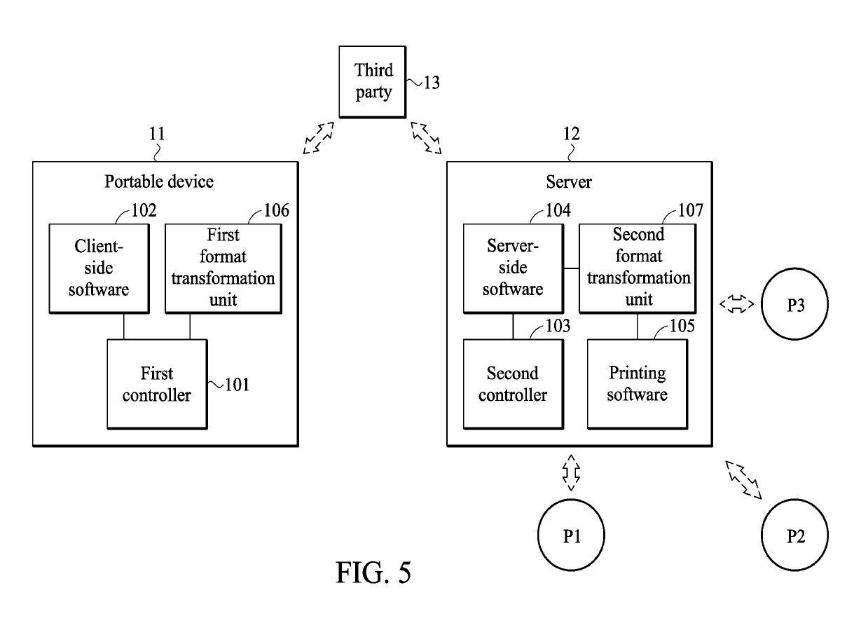

FIG. 5 is a schematic diagram of a portable device printing mechanism with a third party according to another embodiment of the invention. The portable device 11 comprises a first controller 101, a first format transformation unit and client-side software 102. The server 12 comprises a second controller 103, server-side software 104, a second format transformation unit and a printing software 105. The client-side software 102 and the server-side software 104 first execute a security verification procedure with the third part 13 to get the access right of the third party 13. In the present invention, the third party 13 plays a role for exchanging information or data between the portable device 11 and the server 12 only, and the third party 13 does not voluntarily transmit data to the server 12 or the portable device 11. Furthermore, the portable device 11 does not directly communicate with the server 12, and all data, commands, requests or other similar exchanges messages between the portable device 11 and the server 12 must be transferred to the ? by the third party 13.

When the portable device 11 wants to print a first data, the first format transformation unit 106 first transforms the first data into a second data with an XML (Extensible Markup Language) format or creates an XML or a JSON file containing the first data. Extensible Markup Language (XML) is a set of rules for encoding documents in machine-readable form. Then, the first controller 101 executes the client-side software 102 to transmit the second data to the third party 13, and then transmits a print command to the third party 13. The server-side software 104 executed by the second controller 103 monitors the third party 13 to see whether there is data designated to the server 12 or the printers P1, P2 or P3. The user using the portable device 11 can know which printer is available by the client-side software 102 embedded in the portable device 11. In another embodiment, the server 12 transmits available printer information comprising the state of the printers to the third party 13 and the portable device 11 can acquire the printer information to show which printers are available to the user.

The second data contains a label indicating the destination printer. The label may comprise a first unique identification of the printer P1, P2 or P3. The label may also comprise a second unique identification of the server 12. The server-side software 104 monitors the third party 13 continuously or periodically to determine whether there is data designated to the server 12. If yes, the second controller 103 acquires the second data and the second format transformation unit 107 transforms the second data into a third data with the format that can be read by the printer or the original first data. Then, the second controller 103 transmits the transformed second data to the target printer via the printing software 105 for printing. After the target printer finishes printing, the target printer transmits the printing result to the server 12 and the second controller 103 uploads the printing result designated to the portable device 11 to the third party 13 by the server-side software 104. It is noted that the printing result may also contain a label indicating the portable device 11 and the label may comprise a third unique identification of the portable device 11. The server-side software 104 may modify the printing result from the printer P1, P2 or P3 and adds the label corresponding to the portable device 11 to the printing result.

The client-side software 102 monitors the third party 13 continuously or periodically to determine whether there is a printing result designated to the portable device 11. If yes, the first controller 101 acquires the printing result by the client-side software 102. In the present innovation, the third party 13 exchanges information or data between the portable device 11 and the server 12 only, and the third party 13 does not voluntarily transmit data to the server 12 or the portable device 11. In one example, the third party 13 is merely a storage medium and is capable of being accessed by both the server 12 and the portable device 11.

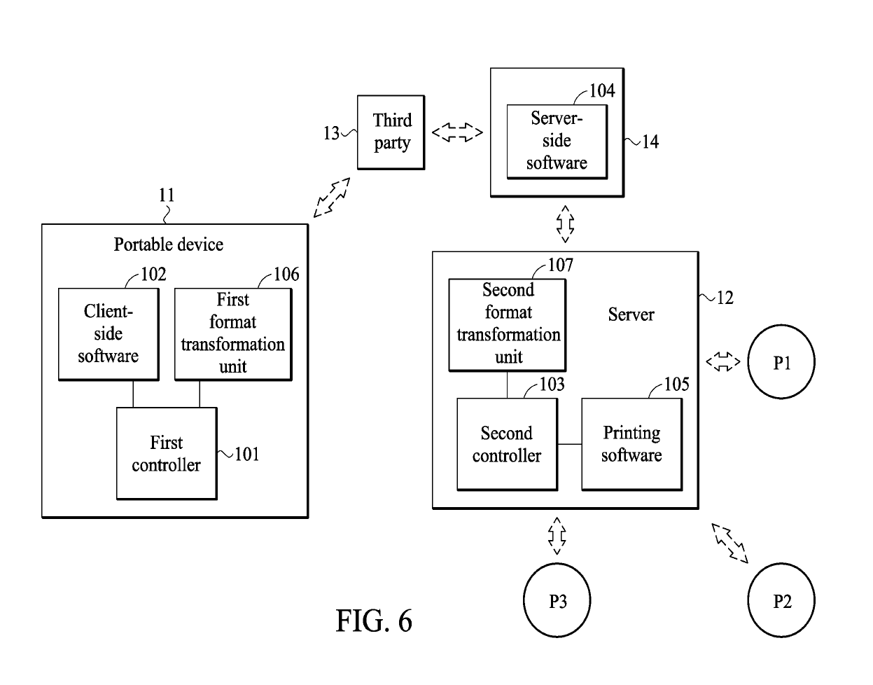

FIG. 6 is a schematic diagram of a portable device printing mechanism with a third party according to another embodiment of the invention. The most different feature of this embodiment is that the server-side software 104 and a second format transform unit 107 are embedded in a dongle 14. The dongle 14 connects to the server 12, a hard disk of the server 12 or a router of an Internet network, and stores the server-side software 104 and corresponding authorization information. In another embodiment, the second format transform unit 107 may be embedded in the server 12.

The portable device 11 comprises a first controller 101 and a client-side software 102. The server 12 comprises a second controller 103 and a printing software 105. The client-side software 102 and the server-side software 104 first execute a security verification procedure with the third party 13 to get the access right of the third party 13. In the present innovation, the third party 13 is used for exchanging the information or data between the portable device 11 and the server 12 only, and the third party 13 does not voluntarily transmit data to the server 12 or the portable device 11. Furthermore, the portable device 11 does not directly communicate with the server 12, and all the data, commands, requests or other similar information exchanged between the portable device 11 and the server 12 must be transferred by the third party 13.

When the portable device 11 wants to print a first data, the first format transformation unit 106 transforms the first data into a second data with an XML (Extensible Markup Language) format or creates an XML or a JSON file containing the first data. Extensible Markup Language (XML) is a set of rules for encoding documents in machine-readable form. Then, the first controller 101 executes the client-side software 102 to transmit the second data to the third party 13, and then transmits a print command to the third party 13. The server-side software 104 executed by the second controller 103 monitors the third party 13 to see whether there is data designated to the server 12 or the printers P1, P2 or P3. The user using the portable device 11 can know which printers are available by the client-side software 102 embedded in the portable device 11 and user can designate the specific printer for printing. The second data contains a label indicating the destination printer. The label may comprise a first unique identification of the printer P1, P2 or P3. The label may also comprise a second unique identification of the server 12. The server-side software 104 monitors the third party 13 continuously or periodically to determine whether there is data designated to the server 12. If yes, the server-side software 104 acquires the second data from the third party 13 and the second format transformation unit 107 transforms the second data into a third data with the format that can be read by the printer or the original first data. Then, the second controller 103 transmits the transformed second data to the target printer via the printing software 105 for printing.

When receiving the transformed second data, the second controller 103 transmits the transformed second data to the target printer and executes the printing software 105. In another embodiment, the printing software 105 deals with the first data to determine which printer is the target printer. In another embodiment, the server 12 transmits an available printer information comprising the state of the printers to the third party 13 and the portable device 11 can acquire the printer information to show which printers are available to the user.

After the target printer finishes printing, the target printer transmits the printing result to the server 12 and the second controller 103 uploads the printing result designated to the portable device 11 to the third party 13 by the server-side software 104. It is noted that the printing result may also contain a label indicating the portable device 11 and the label may comprise a third unique identification of the portable device 11. The client-side software 102 monitors the third party 13 continuously or periodically to determine whether there is a printing result designated to the portable device 11. If yes, the first controller 101 acquires the printing result by the client-side software 102. In the present innovation, the third party 13 exchanges information or data between the portable device 11 and the server 12 only, and the third party 13 does not voluntarily transmit data to the server 12 or the portable device 11. In other words, when the portable device 11 accesses the third party 13, the control of the third party 13 is transferred to the portable device 11, and when the server 12 accesses the third party 13, the control of the third party 13 is transferred to the server 12. In another embodiment, the third party can be accessed by both the portable device 11 and the server 12 at the same time. In one example, the third party 13 is merely a storage medium and is capable of being accessed by both the server 12 and the portable device 11. The third party 13 may contain a security mechanism to verify the server 12 and the portable device 11, and after the verification procedure has passed verification, the server 12 and the portable device 11 are authorized to access the third party 13.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A portable device to print data from a printer via a third party, comprising:
a storage device storing first data; and
a processor to execute a client-side program to print the first data, wherein the client-side program comprises the steps of:
transmitting the first data to the third party;
transmitting a printing command to the third party;
monitoring the third party by a server to check whether there is data designated to the server for printing;
acquiring the first data and transmitting the first data, by the server, to a printer;
transmitting a printing result designated to the portable device, by the server, to the third party; and
acquiring the printing result by the portable device.

2. The device as claimed in claim 1, wherein the first data comprises a destination label containing identification information of the server and/or the printer.

3. The device as claimed in claim 1, wherein the client-side program is stored in a dongle connected to the portable device.

4. The device as claimed in claim 1, wherein the first data is first transformed into a second data with an XML format and then the second data is transmitted to the third party

5. The device as claimed in claim 1, wherein the third party is merely a storage medium for passively storing data from the portable device or the server, and cannot actively transmit data to the portable device or the server.

6. The device as claimed in claim 1, wherein the portable device communicates with the third party via internet or a wireless network.

7. A printing method for a portable device, comprising:
transmitting first data from the portable device to a third party;
transmitting a printing command generated by the portable device to the third party;
monitoring the third party, by a server, to check whether there is data designated to the server for printing;
acquiring the first data and transmitting the first data, by the server, to a printer;
printing the first data by the printer;
transmitting a printing result designated to the portable device, by the server, to the third party; and
acquiring the printing result by the portable device.

8. The method as claimed in claim 7, wherein the method is executed by the portable device.

9. The method as claimed in claim 7, wherein the method is executed by an application program.

10. The method as claimed 9, wherein the application program is stored in a dongle.

11. The method as claimed in claim 10, wherein the dongle may be connected to the server, a router or a hard disk.

12. The method as claimed in claim 7, wherein the first data is first transformed into a second data with an XML format and then the second data is transmitted to the third party.

13. The method as claimed in claim 7, wherein the third party is merely a storage medium for passively storing data from the portable device or the server, and cannot actively transmit data to the portable device or the server.

14. The method as claimed in claim 7, wherein the portable device communicates with the third party via internet or a wireless network.

15. A print system comprising:
a portable device having first data;
a third party; and
a print server connecting to at least one printer, wherein when the portable device wants to print the first data, the portable device transmits the first data and a print command to the third party, and the printer server monitors the third party to determine whether there is data designated to the print server, and if yes, the printer server acquires and transmits the first data to the printer for printing.

16. The system as claimed in claim 15, wherein the third party is merely a storage medium for passively storing data from the portable device and the print server, and cannot actively transmit data to the portable device or the server.

17. The system as claimed in claim 15, wherein the portable device further comprises a client-side program to transmit the first data and a print command to the third party, monitor the third party to determine whether there is a printing result designated to the portable device, and if yes, the client-side program acquire the printing result.

18. The system as claimed in claim 15, wherein after the first data is printed, the printer transmits a printing result to the server and the server uploads the printing result to the third party.

19. The system as claimed in claim 18, wherein the print server modifies the printing result by adding a label corresponding to portable device to the printing result.

20. The system as claimed in claim 15, further comprising:
a server-side program to monitor the third party to determine whether there is data designated to the print server, and if yes, the printer server acquires and transmits the first data to the printer for printing.

21. The system as claimed in claim 20, wherein the application program is stored in a dongle.

22. The method as claimed in claim 21, wherein the dongle may be connected to the print server, a router or a hard disk.

23. The system as claimed in claim 15, wherein the first data is first transformed into a second data with an XML format and then the second data is transmitted to the third party.

24. The system as claimed in claim 23, wherein when the server receives the second data, the print server transforms the second data into a third data with a first format that can be read by the printer.
